(19) United States
(12) Patent Application Publication
(10) Pub. No.: US 2002/0026340 A1
(43) Pub. Date: Feb. 28, 2002

(54) System and method for command and control

(76) Inventor: Stuart A. Kauffman, Santa Fe, NM (US)

Correspondence Address: PENNIE & EDMONDS LLP, 1667 K STREET NW, SUITE 1000, WASHINGTON, DC, 20006

(21) Appl. No.: 09/844,298

(22) Filed: Apr. 30, 2001

Related U.S. Application Data
(63) Continuation of application No. PCT/US99/25398, filed on Oct. 29, 1999.
(60) Provisional application No. 60/106,022, filed on Oct. 29, 1998.

(51) Int. Cl. G06F 17/60

(52) U.S. Cl. 705/7

(57) ABSTRACT

The present invention performs adaptive and robust command and control by identifying operation sequences that are outcome determinative or polyfunctional.

### CROSS REFERENCE TO RELATED APPLICATIONS

This application is a continuation of the U.S. national phase designation of PCT application No. PCT/US99/25398, filed Oct. 29, 1999, the entire contents of which is expressly incorporated herein by reference thereto. This PCT application claimed priority to U.S. provisional application No. 60/106,022 filed on Oct. 29, 1998, the entire content of which is expressly incorporated herein by reference thereto.

### FIELD OF THE INVENTION

The present invention relates generally to a method for command and control. More specifically, the present invention performs adaptive and robust command and control by identifying operation sequences that are outcome determinative or polyfunctional.

### BACKGROUND

Previous research has applied techniques involving technology graphs and landscape representation to operations management as described in U.S. patent application Ser. No. 09/345,441, the contents of which are herein incorporated by reference. But previous research has not applied these techniques to command and control problems.

Accordingly, there exists a need to perform adaptive and robust command and control using technology graphs and landscape representations.

### SUMMARY OF THE INVENTION

The present invention presents a system and method that performs adaptive and robust command and control by identifying operation sequences that are outcome determinative or polyfunctional.

It is an aspect of the present invention to present a method for performing command and control comprising the steps of:

defining a plurality of subtasks;

determining one or more of said subtasks that causally effect one or more fundamental outcomes wherein said fundamental outcomes comprise winning outcomes and losing outcomes; and

determining values for said order parameters to achieve a winning one of said fundamental outcomes.

### DETAILED DESCRIPTION OF THE PREFERRED EMBODIMENT

The present invention will be explained in the context of a military battlefield consisting of Red and Blue forces. However, as is known to persons of ordinary skill in the art, the techniques of the present invention are applicable to any problems using command and control.

The present invention addresses three approaches to command and control. First, in the joint strategy spaces of Red and Blue forces in the defined battle space, are there a modest number of alternative fundamental outcomes of the battle? If so, can we define “phase volumes” in strategy space corresponding to each of these different outcomes? Inside of each such volume, the combined Red and Blue strategies lead to the same fundamental outcome. Crossing between phase volumes to neighboring different fundamental outcomes corresponds to “phase transitions” in the physicist's sense. Physicists speak of “order parameters”—the causally effective collective conditions that define the phase transition. For example, in a outcome. Crossing between phase volumes to neighboring different fundamental outcomes corresponds to “phase transitions” in the physicist's sense. Physicists speak of “order parameters”—the causally effective collective conditions that define the phase transition. For example, in a ferromagnet, the order parameter is the number of magnetic dipoles, or spins pointing in the same direction. Since spins “want” to point in the same direction, when the thermalizing effect of temperature is lowered, the collective reduction in energy in spin alignments overcomes the randomizing forces of thermalization, and magnetization spontaneously occurs. In a similar way, we define “collective tasks and subtasks” which must be achieved to remain in a given phase volume in battle space to assure a positive outcome, or which must be transgressed to exit a “losing” phase volume battle outcome and transition into a “winning” volume. The first approach chooses sequences of subtasks and alternative sets of subtasks which collectively might assure that the battle has the desired outcome.

The second approach to command and control concerns robust strategic and tactical operations. The approach brings substantial new tools to bear that yield useful understanding and supplies decision support tools for actual military operations. The fundamental ideas rest on the new concept of a “technology graph” of all the alternative pathways to achieve sets of tasks, as well as sets of neighboring alternative tasks, leading to one or a set of ultimate goals. Technology graphs were explained in U.S. application Ser. No. 09/345,441, filed Jul. 1, 1999, the contents of which are herein incorporated by reference. As explained in that patent application, the technology graph is a principled mathematical framework in which to analyze robust pathways to a single objective, or a set of alternative objectives. Here “robust” is quantitatively defined in terms of the number of alternative nearby pathways to each task, where a large number of alternatives implies that failure along any one segment of any pathway is readily overcome by graceful deviation to a neighboring pathway. In consideration of a set of alternative tasks or objectives, a related sense of robust identifies the node subtasks that are optimally on the pathways to multiple alternative objectives and allow graceful redeployment to achieve changing objectives.

The second approach also concerns the fundamental idea of a technology graph, a second major concept concerns a generic phase transition in problem solvability from a “living dead” regime to a “survivable” regime in the face of a coevolving enemy force. The living dead regime generically occurs when we attempt to be too efficient. The survivable regime arises when we relax our efficiency requirements just enough to reduce conflicting constraints in the problem space to a point beyond the phase transition. This phase transition is quantifiable, has been demonstrated in several cases, and leads to the clear implication that we should operate in the survivable regime sufficiently near the living dead regime to assure efficiency, yet far enough back from the phase transition in the survivable regime to withstand attrition and uncertainties due to the fog of war.

The third approach of the present invention concerns optimal command and control structures, command by direction, by plan, or by intent, in the face of the need for adaptive, flexible, robust, survivable operations. Recent results in “complexity” exhibit clear quantitative cases in which centralized decision making is best, and clear alternative cases in which optimal performance is achieved by distributed decision making in modular units which each make decisions to optimize local goals regardless of the effects those decisions may have of neighboring modules with different goals. The reason such “selfish” modular decision making can e more successful than centralized command is that the “selfish” units ignore some of the conflicting constraints in the entire problem space. The collective effect is that the system avoids becoming trapped on very poor compromise solutions and can jointly “explore” its space of operations ore widely. In specific cases, it now appears that optimal collective decision making in the face of complex conflicting constraints occurs at a phase transition between an ordered regime and a chaotic regime. One internal signature of such a collectively adaptive system is that a power law distribution of many small and few large “avalanches” of change propagate through adapting organization. The present invention uses model battlespace and agent based models of Red and Blue forces to assess alternative ways to achieve flexible adaptive command and control.

It is important to stress that the new criteria above for distributed command and control—the avoidance of poor compromises, is a new concept, unrelated to the difficulties of command by direction when the battlespace is only partially known to the commander, and unrelated to the difficulties of direction by plan when plans appear to many to be generically fragile and non-robust. Rather, the core issue concerns organization for the capacity to adapt rapidly and robustly while operating in the survivable regime noted above.

A central feature of the approaches of the present invention is a “crude look at the whole”. By using agent based models of simplified battle spaces, we can examine the interrelations between opposing force structures and capabilities, strategy spaces with respect to operations, the consequent requirements for intelligence which feedback and guide the evolving battle, the robustness of operations and the emergence of “unintended consequences” as our adaptive agents explore their strategy spaces. The unintended consequences will find the “chinks” in Red and Blue team strategies. If we can succeed in our first objective of finding alternative phase volumes in the strategy space of the battlespace, these chinks help define the boundaries etween volumes where Red force and Blue force win.

As previously mentioned, the present invention will be explained in the context of a military battlefield consisting of Red and Blue forces. The exemplary battlefield model consists of two political domains with a boundary, both bordering an oceanfront. Red forces occupy the northern domain. Blue forces are located in the southern domain. The purpose of blue force is to prevent any incursion across the boundary into its territory. Red's objective is to take over Blue territory. The exemplary battlefield model further includes battle agents in the air, (A/C Helo), land(Tanks, SLs SAM), and sea (Ships MSLs SAM) for Blue and Red forces. Red and blue forces have biological and chemical weapons as well. Agent characteristics include reach (range and speed), and lethality. Intelligences assets include satellites, UAVs, SIGINT. Command and control structures. Targets—air/land/sea, C2 facilities, wpns storage, POL, infrastructure (bridges etc.) The measures of effectiveness include time, attrition and cost.

The battlefield model includes agent based models of entire battlespace to different desired levels of disaggregation. More generally, agents can represent battalions, corps, divisions, down to individual soldiers. In general, agents are endowed with a set of “genetic characteristics”. These include the fundamental characterization of the “primitive moves” each human or battle agent can make. Thus, tanks have features of speed, range, gas utilization, firepower, accuracy, vulnerability profiles. A commander of a tank corp might have characteristics concerning propensities to attack or retreat in definable contexts (for example as defined by “doctrine” in one or more default hierarchies), experience level (modeled by the extent of off line simulation the commander can “run” to assess and make decisions), a prioritized set of targets, information about the possible primitive and compound actions of friendly and enemy agents.

However, as is known to persons of ordinary skill in the art, the techniques of the present invention are not dependent on any particular model because they are applicable to any problems using command and control.

We begin by discussing the second approach of the present invention involving the “Technology Graph” of possible sequences of operations. The technology graph is a new mathematical framework to consider robust operations.

Without limitation, the technology graph will be explained in the context of a “Lego world”. Consider a set of primitive Lego parts, lxi, 1×2, 1×3, 1×4 blocks, and primitive operations—attaching two blocks or separating two blocks. Define a “founder set” with a very large number of primitive parts. Consider in Rank 1, all possible unique objects that can be constructed from the founder set in a single move 2 has all unique Lego objects that can be constructed in two steps, rank 3 has all unique Lego objects that can be constructed in three steps, etc. A technology graph is a set of objects and transformations among those objects. We can, if we wish, define specific machines, themselves made of Lego objects, that carry out each of the different primitive lego construction or disassembly operations. In general, the technology graph is infinite.

A core use of the technology graph is to define alternative useful senses of “robustly constructable, or robustly achievable. In the case of Lego, suppose a specific Lego house is first constructed in 20 steps, hence is in rank 20. It might be the case that there is but one pathway from the founder set to the house in 20 steps, or there may be thousands of alternative pathways to the house in 20 steps. In the latter case, we say that the house is robustly constructable. Intuitively, if there are many alternative pathways, then it will be difficult to block assembly of the house in 20 steps, for blockage of one pathway at a step can typically be gracefully overcome by deviation to a nearby construction pathway. A closely related notion of robustly constructable or achievable is to ask how the number of ways of making the house increase after the first occasion it can be make, hence in 21, 22, 23, etc steps. Perhaps the number of ways increases slowly, perhaps hyperexponentially. In the latter case, it may be very worth while constructing the object in 22 steps because so many redundant pathways exist that blocking construction of the house by substantial attrition of parts and machines cannot be achieved. Construction is robust.

A related but different sense of robustly constructable considers a set of final objects, or objectives or tasks. Consider, then, a lego house and a lego house with a chimney. Intuitively, a family of objects, objectives, or tasks, is robustly achievable if pathways to one of the objects are well on the way to others of the objects. Thus, consider a specific way to make the house and ask what must be done from that pathway to divert to a house with a chimney. Perhaps the chimney can simply be added. More generally, the house must be deconstructed to some stage, then rebuilt to include the chimney. Consider for each way to build the house, the branch point to the house with the chimney. These branch points identify maximum intermediate objects or operations on the pathway to both the house and house with the chimney.

In building a house, boards and nails are primitives, the house is the completed task. But there are intermediate complexity objects such as framed up walls and windows that are useful. Why? Essentially, the branch points in the technology graph to a family of objects or objectives identify intermediate complexity polyfunctional objects/operations—polyfunctional in the sense that multiple end objectives can be reached using the intermediate object/operation.

But there is a further subtlety. The maximum intermediate branch point might have only a single way onwards to construct the house, and a single way to construct the house with the chimney. If, instead, a point a few steps before the last branch point is considered as the intermediate complexity object' operation, there may be thousands of ways to reach the house and to reach the house with the chimney. If so, then achievement of either the house or house with the chimney will be robust in the face of attrition of parts and machines. In short, in a manufacturing context, such intermediate objects are superb to stockpile, and cost no more than stockpiling the maximum complexity intermediate objects. In an operational context, the analogue of intermediate polyfunctional objects is intermediate polyfunctional operation˜ which retain flexibility to robustly achieve a variety of alternative objectives.

In short, technology graphs are the proper mathematical framework to identify robustly achievable sequences of tasks to subgoals, alternative subgoals, and final goals.

The second approach to the present invention generalizes from Lego world via use of object oriented programing such as the use of Java objects. In Java, an “engine block”, “piston”, and “carburetor” objects are characterized by “is a”, “does a”, “needs a”, “uses a” features. With proper search engines, the engine block and piston can “know” that the piston fits into the cylinder hole to create a completed cylinder. In effect, the Java objects are a generative grammar of parts and transformations of parts that are complements and substitutes, that yields the technology graph of all objects constructable from those initial parts.

In the context of operations, the appropriate set of objects will include the primitive moves of which battle agents and agents are capable, together with the corresponding “is a”, “does a”, “uses a”, “needs a” match features. One essential aim of the present invention is to establish a set of primitive objects and operations that yields an initial modestly sophisticated technology graph for the space of battle operations of Red and Blue forces.

Given a technology graph, and a specification of objects or objectives, or a sequence of subobjectives leading to a final objective, the task of searching the technology graph for robust pathways is the next serious problem. In general, we propose to use “ant algorithms” and other reinforcement learning algorithms, to find “optimal robust” pathways to a sequence of sub-objectives.

There are two major issues to be confronted next. First, we may have a multiplicity of measures of effectiveness rather than a single measure. Thus, if we use time, attrition nd cost as three such measures, we may have no clear conception of the relative importance of each of these easures to our final purposes. In this case, the natural solution concept considers “global pareto optimal” surfaces along which it is not possible to improve one of the three OEs without making one or more of the remaining MOEs worse.

The second major issue is less well known. It appears to be generically the case that hard combinatorial optimization roblems exhibit a phase transition between a living dead and a survivable regime. We begin with the analogy of a bromine fog in the Alps. If one is in the fog, one dies. If the fog is higher than Mont Blanc, everyone dies. If the fog is lower and Mont Blanc, the Eiger and the Matterhorn jut into the sunlight, then climbers near those peaks can survive. But what if plate tectonics deform the mountainscape? If Mont Blanc slips into the fog, climbers near that peak will die, for the distances to any new peaks that now jut into the sunlight are typically large and cannot be reached without passing into the lethal fog. This “isolated peaks” regime is also, therefore, the “living dead”. Let the fog drift lower and more and more peaks jut into the sunlight. Eventually, when the fog is low enough, it becomes possible to walk across the Alps always remaining in the sunlight. Mathematically, this is a phase transition from the isolated peaks regime to a “percolating web” regime. Note that now, if plate tectonics deforms the landscape, hikers about to dip into the fog can almost always step sideways in one or more directions and remain in the sunshine. Thus, the percolating webs regime is survivable in the face of deformation of the landscape.

Deformation of the landscape due to plate tectonics is the analogue of deformation of the payoff landscape in a space of operations for Blue Force as Red Force alters its strategies.

Several points about this phase transition are essential. First, it is now well established for several hard combinatorial optimization problems and is likely to be typical of most realistic hard problems, including military operations. To be concrete, consider a job shop problem where M machines are to construct 0 objects. Each object must “'sit” on each machine in some fixed order for some period of time. A schedule is an assignment of objects to machines such that all objects are constructed. The total time to carry out the schedule is called “Makespan”, and is the common measure of effectiveness. By defining the concept of nearby schedulers, for example, swapping the order of assignment of an object to a different machine, and by considering “makespan” as the “fitness” or “cost” of a schedule, a fitness or cost landscape is achieved. To preserve the image of the Alps, consider low cost equal to high fitness of a schedule, then the aim is to find high fitness peaks in the space of schedulers.

Short makespan is harder to achieve than long makespan, hence short makespan is analogous to the bromine fog being high. As makespan decreases from a large—easy to achieve value, at first there remains a roughly constant number of schedules, then, at a critical makespan, the number of solutions turns a corner and falls rapidly. This corner is the phase transition from the percolating webs, survivable regime, into the isolated peaks regime. We stress than a variety of mathematical measures characterize this phase transition, including the failure, in the isolated peaks regime, to find percolating webs of solutions, and other measures such as the average Hausdorf dimensionality of the set of nearby schedules at a given makespan as radius from that schedule in increased.

Furthermore, there is an essential relationship between the robust constructability discussed with respect to technology graphs and the phase transition. Consider the case of the job shop problem. If the order in which objects can be placed on machines can be permuted, the number of conflicting constraints is reduced. Then the fitness peaks in the schedule landscape become higher and the landscape is more smoothly correlated. In turn, the percolating webs regime occurs at a higher fitness—hence at a shorter makespan. Thus, increasing the number of steps that can be permuted shifts the phase transition to the left, to shorter makespan.

But the very point of the technology graph and robust constructability or achievability, is that robust pathways are sufficiently redundant that there are many nearby athways to the same objective. In turn, this means that steps to achieve the objective can be permuted or otherwise ltered. Robustness is therefore associated with reducing onflicting constraints˜ thereby making the cost landscape in the space of operations in the technology graph to achieve the objectives have higher peaks. The survivable regime occurs at higher values of the measures of effectiveness.

In our combined development of the technology graph and attlespace, we propose to implement battle plans to achieve a sequence of subtasks, as discussed below. The present invention examines the phase transition in the context of simplified battle plans. Thus, using the technology graph, we ill find large numbers of alternative pathways to each subgoal. For each pathway, we will measure time, attrition, and cost, our three measures of effectiveness. Therefore, we ill build up a profile for each MOE for each subgoal.

Further uses of the concept of the phase transition should be mentioned. In the absence of attrition by Red Force, Blue Force should presumably operate near the phase transition but in the survivable regime such that it can cope with alterations in its cost landscape as Red Force alters that landscape by altering its own strategy. On the other hand, Red Force is busy trying to destroy Blue Force. We can begin to discover how far “back” of the phase transition, deeper in the survivable regime, but at worse MOE values, Blue Force should operate in order to remain in the survivable regime. A first approach is random, Poisson destruction of Blue Force agents. More difficult, each Red Force strategy will correspond to specific non-random patterns of loss of Blue Force agents. This requires Investigation.

As the present invention discovers the phase transition, and where Blue force should operate as a function of features of Red Force strategy, it uses “ant” algorithms that automatically optimize for the requisite robustness to compensate for attrition, and to confront the persistent need to exploit alternative approaches to old or new subgoals by graceful redeployment.

The second approach of the present invention is described next. Consider a World War II sea battle consisting of a convoy and wolf pack. How many fundamentally different ays can this battle unfold? Are there thousands of different atterns? Hundreds of patterns? Tens of patterns? Intuitively, but perhaps wrongly, it seems reasonable that there are a modest number of fundamentally different ways such a battle can unfold. Suppose there were fourteen different patterns. If this is true, then it should be possible to characterize the strategy spaces of the convoy and the wolf pack and ask for each pair of strategies, where a strategy is a specific sequence of moves throughout the whole battle, which of the modest number of outcomes of the battle happened. If this could be achieved, then the joint strategy space of the convoy and the wolf pack could be partitioned into fourteen phase volumes corresponding to the different fundamental patterns. Think of these fourteen volumes as fourteen balloons colored blue, red and white, meaning Blue force wins, Red force wins, and white corresponding to a “draw”. The fourteen volumes are arranged somehow in strategy space. If we are the blue team convoy, we want to be in a blue balloon as far as possible from a white or red balloon, subject to our MOEs. If we are in a blue balloon next to a white or red balloon, we surely do not want to cross into one of those neighboring balloons.

In the physicist's sense of “order parameters”, it is reasonable that some particular combinations of essential subtasks characterize the frontiers between two adjacent balloons. Characterization of those subtasks across the different boundaries of one balloon would characterize the subgoals that must be achieved to remain in that balloon to defeated to cross into an adjacent balloon. In short, the present invention characterizes fundamental alternative outcomes of a battle space so that the resulting phase volumes in strategy space and phase transition surfaces between those volumes identify critical single or alternative sequences of subtasks that are determinative of the outcome of the battle.

The present invention characterizes all the primitive moves Red and Blue forces can make, and characterizes “stopping rules” at which the battle will end. Then, the present invention uses agent based models to play millions of random battles with random sequences of actions by Red and Blue forces. This random sample from the Red and Blue Force strategy spaces will sample the strategy space and reveals whether there are a modest number of alternative outcomes of the battle. The present invention casts each of the millions of battle strategy pairs into the corresponding balloons, and seek the boundaries between balloons. Even discovering that such phase volumes exist, their typical layout in strategy space (for example are red and blue ballon0ns randomly intermixed in the joint scraggy space, or do red and blue balloons typically cluster near one another), and discovery of the typical the size distribution of the balloons and so forth would be of deep interest.

The third approach will be described next. The third approach is based on optimal command and control structures on a generalization to a military operational framework of our current and developing organizational simulation model, which is described in patent application Ser. No. 09/345,441 filed Jul. 1, 1999, the contents of which are herein incorporated by reference. Our discussion occurs in the context of: 1) Org-Sim as a platform to study the fitness or cost landscape represented by an organization's space of operations and need to optimize robust performance. Associated with this fitness landscape is a framework to understand the statistics of learning curves in organizations; 2) Org-Sim as a platform to study the relationship between the space of operations, the goals of the organization, and the optimal organizational-management structure to achieve those goals; 3) Alternative insights into the requirements for an organization to adapt flexibly and gracefully as its world changes.

Org-Sim is simulates and studies systems such as a gas refinery which imports raw materials, stores those materials, processes the raw materials into a variety of products, stores and ships those products into an uncertain market environment.

The Org-Sim platform consists of a set of nodes and flows. The nodes represent various stages in the assembly and processing operation such as raw inputs of crude oil, storage facilities, cracking towers, subsequent storage facilities, and so forth. Arrows between nodes depict flows. At the simplest level, the operations of the refinery is given by, in general, non-linear differential equations representing the “transfer function” of inputs to outputs at each node. Already at this simplest level, the platform sets up in the general, hard combinatorial optimization problem for the refinery. How should each node operate, and how should the transfer functions be altered at each node if that is feasible, to optimize one or more measures of effectiveness of the entire refinery.

The combinatorial optimization problem sets up the framework for understanding what economists call “learning by doing”. Learning curves in economics record the well known fact that the cost per unit produced falls by a rough constant fraction, typically 5%-10%, for each doubling of total quantity produced. Bios scientists together with outside economists are currently publishing the first microscopic models accounting for learning curves. It appears that these curves reflect the statistics of search for improvements in operations over the “cost landscape” for the alternative ways of operating the plant. The cost landscape is given by all the alternative ways to operate the plant and a neighbor relation specifying which ways are “near” one another. The distribution of costs over this high dimensional space is the cost landscape.

The typical features of improvement on such landscapes is that at each improvement step, the number of directions of further improvement falls by a constant fraction while the amount of improvement is typically a constant fraction of the previous improvement. Plotting the logarithm of cumulative improvement tries (hence production runs) on the X axis, and logarithm of cost per unit on the Y axis yields the familiar near power law learning curve. Thus, Org-Sim embodies the “technological landscape” that must be optimized, and the statistics of that landscape govern learning curves.

The present invention includes techniques based on Markov random fields to measure sets of nearby “production runs” in the refinery, record their different costs or effectiveness, in the model or in a real plant, and deduce the statistical structure of the cost landscape. From the statistical structure and known measures of a modest number of costs at actual operational points in the space of operations, we can “fit” and interpolate the rest of the landscape at untried points of operation. We believe that these techniques can be generalized to a space of military operations as well.

Org-Sim, even at this simple level, also embodies the “mid game chess board” problem. How does one know the value of a mid game board position? Similarly what, exactly, should the manager of cracking tower 3 do to optimize the performance of the entire plant? In a military setting, what subgoals should be set to optimize an overall strategy? The present invention takes two sub-approaches to this issue, one based on reenforcement learning, including “ant” algorithms. These algorithms scout out alternative pathways of sequential operations and build up insight into the most successful, including the most robustly successful in the “technology graph” sense, pathways to the objective.

The second sub-approach is based on the concept of the properly adaptive organization. In general, there is a trade off between exploitation and exploration. In the landscape context, exploitation means adaptive search that climbs steadily uphill to a nearby fitness peak. But in a high dimensional space with very many peaks in a rugged landscape, that peak is typically a poor one, a poor compromise between the conflicting constraints which create the operational cost landscape. Exploration constitutes making more dramatic large experiments, exploring more distant points on the landscape which may be fitter, and more importantly, may lie on slopes leading to even higher peaks.

The present invention includes procedures to measure the correlation structure of such landscapes, namely how much one knows about fitness at different distances from any given point whose fitness is know. These landscapes techniques are described in U.S. patent application Ser. No. 09/345,441, the contents of which are herein incorporated by reference. The more rugged the landscape, the more rapidly the correlation falls off, typically exponentially, with distance. Generically, when fitness is low, it is optimal to search beyond the correlation length of the landscape where very much fitter positions can be found. If one restricted search to nearby points, the fact that the landscape is correlated would imply that their fitnesses cannot be much greater or less than the current point. By search a long distance away, the search process escapes this correlation constraint. As fitness improves, “long jump” search will typically discard the high fitness ground achieved, and it is better to search closer to the current position. This general feature of search on rugged landscapes suggests that optimal adaptation will occur with wider experimentation early in learning, the settle to refined small variations.

This general feature of optimal search on rugged operations landscapes, in the military context, should be able to inform both learning by doing in training, and should have impact on dispersal of authority down the military hierarchy to lower levels with more generalized command by intent to those lower levels when more wide ranging adaptive exploration is required.

To study optimal management structure as a function of the task the organization faces, and a function of the current fitness of the organization, Org-Sim instantiates a second level: Management. Each node and flow is under the control of a direct line manager. Managers report to high managers in a definable hierarchy. Each manager is characterized by features such as line of sight, experience, authority and a decision queue. Line of sight refers to the number of nearby nodes that manager has information about.

Experience is modeled by allowing more experienced managers to run, off line, more simulations of the “plant” before making a decision. Authority is central. Authority allows a manager at a given level to act as follows: If the manager believes, based on his simulations of the organization that a change in operations will reduce performance, he does not do it. If he believes that the change in operations will increase performance up to a given limit, the limit of his authority, he may carry out such a change. If the expected improvement exceeds that limit, he bucks the decision upstairs to the next higher manager. Managers have decision queues, so, if overloaded, some decisions will not be made in a timely way. Information may be degraded passing up and down the chain of command.

The Org-Sim framework inclusive of a space of operations and reconfigurable management structure allows us to investigate optimal management structure as a function of the goals of the organization, the structure of the set of processes leading to those goals, the resultant fitness landscape in the space of operations, and the rate of change of those goals as the external environment changes.

In a number of settings with hard combinatorial optimization problems, the optimal balance between exploration and exploitation appears to occur in an “ordered regime” near a phase transition to chaos. In general, adaptation by altering the operations in one part of an organization create the requirement to alter operations in nearby parts of the organization to accommodate the initial change. Thus, “avalanches of changes” can arise. In the ordered regime, alterations in the operation of one part of the organization propagates no, or at best, a few small avalanches. The organization is “too rigid”. In the chaotic regime, an alteration at any point typically unleashes huge avalanches that spreads throughout much of the organization. Indeed, the size of the large avalanches scale linearly with the size of the system. At the phase transition between the ordered and chaotic regime, many small avalanches and relatively few large avalanches propagate through the system. The size distribution of the avalanches is a power-law, with a finite cut off that appears to scale as roughly a square root of the size of the system.

In several environments we have found that organizations poised in the ordered regime near this phase transition do an optimal job of optimizing a fixed hard combinatorial optimization problem in a space of operations, and do an optimal job at the same time of adaptively tracking a deforming operations environment.

The present invention determines optimal command structures in the context of our simplified battlespace model. Part of the puzzle of command by direction is precisely our finding that, even with full information, many hard optimization problems are better solved by breaking the system into coevolving subunits, each selfishly pursuing its own goals, even at the partial expense of other subgroups in the organization. This selfish behavior assures that some of the conflicting constraints in the optimization problem are ignored some of the time, and prevents the system becoming trapped on poor local fitness peaks that are poor compromises. Indeed, it is just in this setting that we have found that, for simple problems with relatively simple smooth few peaked landscapes, a single commander performs best, but that as the problem space becomes more rugged and multipeaked, it is best to break the system into coevolving, selfish “units” or “patches”, whose sizes need to be carefully tuned such that the entire system is in the ordered regime near the phase transition to chaos.

Part of the puzzle with respect to direction by plan is the need to set a sensible sequence of subgoals. It is not clear how a complex battle unfolds without such statements of subgoals and the capacity to alter them in a coordinated way. On the other hand, it appears that experience shows that such elaborate plans tend to be out of date as soon as the battle actually starts. This suggests that we try to combine our unfolding understanding of robust, reliable, flexible, survivable operations, in the technology graph sense above, as a battle unfolds and coadaptation by Red and Blue Forces occurs, with an attempt to understand what mixture of command by direction, by plan, and by intent work most effectively in which unfolding situations. Our own preliminary prejudice is that optimum survivable performance requires operation in the flexible survivable regime of the technology graph, which then requires the military organization to be in the ordered regime near the edge of chaos in order to learn rapidly how to achieve changing operational plans and objectives in a rapidly unfolding and confusing battlespace.

While the above invention has been described with reference to certain preferred embodiments, the scope of the present invention is not limited to these embodiments. One skill in the art may find variations of these preferred embodiments which, nevertheless, fall within the spirit of the present invention, whose scope is defined by the claims set forth below.

1. A method for adaptive command and control comprising the steps of:
defining a plurality of subtasks;
determining one or more of said subtasks that causally effect one or more fundamental outcomes wherein said fundamental outcomes comprise winning outcomes and losing outcomes; and
determining values for said order parameters to achieve a winning one of said fundamental outcomes.
